(19) United States
(12) Patent Application Publication
(10) Pub. No.: US 2018/0335684 A1
(43) Pub. Date: Nov. 22, 2018

(54) System, Method, and Apparatus for Taking Pictures

(71) Applicant: DOK SOLUTION LLC, Largo, FL (US)

(72) Inventor: Jack Strauser, Largo, FL (US)

(73) Assignee: DOK SOLUTION LLC, Largo, FL (US)

(21) Appl. No.: 15/600,283

(22) Filed: May 19, 2017

(51) Int. Cl. G03B 17/56; F16M 11/06

(52) U.S. Cl. CPC G03B 17/561; G08C 2201/91; F16M 11/06

(57) ABSTRACT

An angle adjustment device includes a device interface and a first motor that is held within an upper portion enclosure. The first motor is coupled to the device interface so as upon receipt of a first electrical signal from a controller; the first motor adjusts an angle of the device interface. A second motor is held within a lower portion enclosure. The upper portion enclosure is interfaced to the second motor so as upon receipt of a second electrical signal from the controller; the second motor adjusts a rotation angle of the upper portion enclosure and, therefore, a rotation angle of the device interface. The lower portion enclosure has a receiver for receiving, for example, a tripod interface.

### FIELD

This invention relates to the field of photography and more particularly to a system for adjusting tilt and angle when photographing the photographer.

### BACKGROUND

With advances in smartphone technology and camera technology, the ability to take high-quality photographs is now possible at times that were previously unlikely. Coupled with the ability to post images of oneself or a group of individuals that includes the photographer, many look for better ways to photograph themselves or their group, as there is often no other person around who will take a picture of the person or group.

To this end, a device known as a selfie stick has been introduced. The selfie sticks have a clip or mechanism for holding the camera/smartphone and a mechanism for initiating taking of the photograph by the camera/smartphone. The camera/smartphone is installed in the clip and, when ready, the mechanism for initiating is activated to take the photograph.

The selfie stick has been used in countless settings, but an observation of those using such a device often reveals that the user makes many adjustments to the camera/smartphone to get the elevation, angle, and distance correct to include the appropriate portion of the subject(s). This makes it more difficult to obtain good photographs as adjustments are made manually, requiring relocation of the camera/smartphone to the locale of the photographer and then back to the distant location where the photographer wishes to take the picture from. Additionally, many selfie stick devices have an actuator that initiates taking of the photograph, but having the actuator on the selfie stick itself creates unwanted movement of the selfie stick, impairing the taking of great photographs.

What is needed is a device that will provide remote adjustment of tilt and angle of a smartphone/camera.

### SUMMARY

In one embodiment, an angle adjustment device is disclosed including a device interface and a first electrically operated actuation device that is coupled to the device interface. The first electrically operated actuation device adjusting an angle of the device interface under electrical control from a controller. A second electrically operated actuation device is coupled to the first electrically operated actuation device. The second electrically operated actuation device adjusts a rotation angle of the device interface under electrical control from the controller.

In another embodiment, an angle adjustment device is disclosed including a device interface and a first electrically operated actuation device held within an upper portion enclosure. The first electrically operated actuation device is coupled to the device interface so as upon receipt of a first electrical signal from a controller; the first electrically operated actuation device adjusts an angle of the device interface. A second electrically operated actuation device held within a lower portion enclosure. The upper portion enclosure is interfaced to the second electrically operated actuation device so as upon receipt of a second electrical signal from the controller; the second electrically operated actuation device adjusts a rotation angle of the upper portion enclosure and, therefore, a rotation angle of the device interface.

In another embodiment, an angle adjustment device is disclosed including a device interface and a first motor that is held within an upper portion enclosure. The first motor is coupled to the device interface so as upon receipt of a first electrical signal from a controller; the first motor adjusts an angle of the device interface. A second motor is held within a lower portion enclosure. The upper portion enclosure is interfaced to the second motor so as upon receipt of a second electrical signal from the controller; the second motor adjusts a rotation angle of the upper portion enclosure and, therefore, a rotation angle of the device interface. The lower portion enclosure has a receiver for receiving, for example, a tripod interface.

### BRIEF DESCRIPTION OF THE DRAWINGS

The invention can be best understood by those having ordinary skill in the art by reference to the following detailed description when considered in conjunction with the accompanying drawings in which:

FIG. 1A illustrates a perspective view of an adjustable holder.

FIG. 1B illustrates a perspective view of the adjustable holder in a second position.

FIG. 2 illustrates an exploded perspective view of an angle adjustment device used in conjunction with a tripod.

FIG. 3 illustrates a perspective view of the angle adjustment device used in conjunction with a tripod holding a device (shown in dashed lines to show details of the holder).

FIG. 4 illustrates a perspective view of the angle adjustment device used in conjunction with a tripod, shown holding a device.

FIG. 5 illustrates a cross-sectional view of the angle adjustment device along lines 5-5 of FIG. 2.

FIG. 6 illustrates a plan view of a remote control for use with the angle adjustment device.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term photograph is used interchangeably with any type of image photography, including, but not limited to, digital imaging, film photography, video imaging (film or digital), and wireless transmission of images/video.

Throughout this description, the term motor is used as an example of an electrically controlled device that causes movement. Any other similar device is anticipated such as a servo-motor, an electromagnetically operated ratchet, a solenoid, etc.

Throughout this description, a tripod is used as an example of a device upon which the angle adjustment device is mounted, though it is anticipated that the angle adjustment device be free-standing or mounted to any other type of device, for example, a mono-pod (one-legged tripod), a selfie stick, etc.

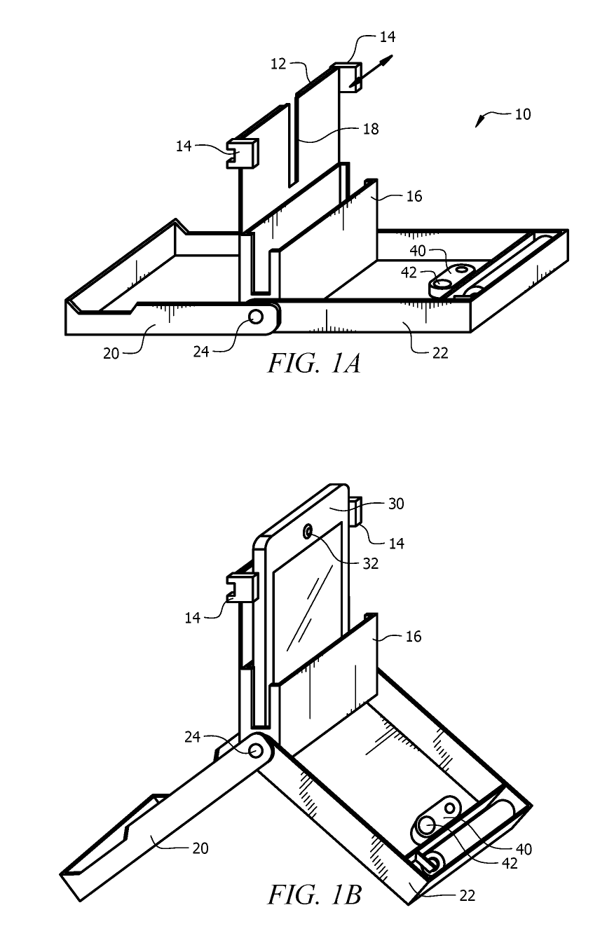

Referring to FIGS. 1A and 1B, perspective views of a holder 10 that is adjustable are shown. The adjustable holder 10 provides a way to hold a device 30 such as a camera or smartphone while taking pictures, for example taking pictures from a smartphone. The device 30 (e.g. smartphone) rests in a cradle formed between a front wall 16 and a back wall 12. As devices 30 come in many sizes, the side stops 14 are preferably adjustable to allow for width expansion/contraction of the holder 10. As it is anticipated that, in some uses of the holder 10, a user will connect a source of power to the device 30, a slot 18 is formed in the back wall 12 for routing a power cable.

The holder 10 is hinged at a pivot 24 and folds into a neat package that is roughly the width of the cradle between the back wall 12 and front wall 16. A rear leg 20 extends from the pivot 24 and a front leg 22 extends in an opposing direction from the pivot 24. As shown in FIG. 1B holding a device 30, the holder 10 is adjustable by way of the pivot 24 to elevate the device 30, for example, when taking a picture or video.

In some embodiments, the holder 10 includes a clip that removably holds a transmitter 40. The transmitter 40 transmits a signal to the device 30 when a button 42 is pressed and the device 30 is configured to receive the signal and, responsive to receiving the signal, the device initiates the photographic process (e.g. takes a picture or starts taking a movie.

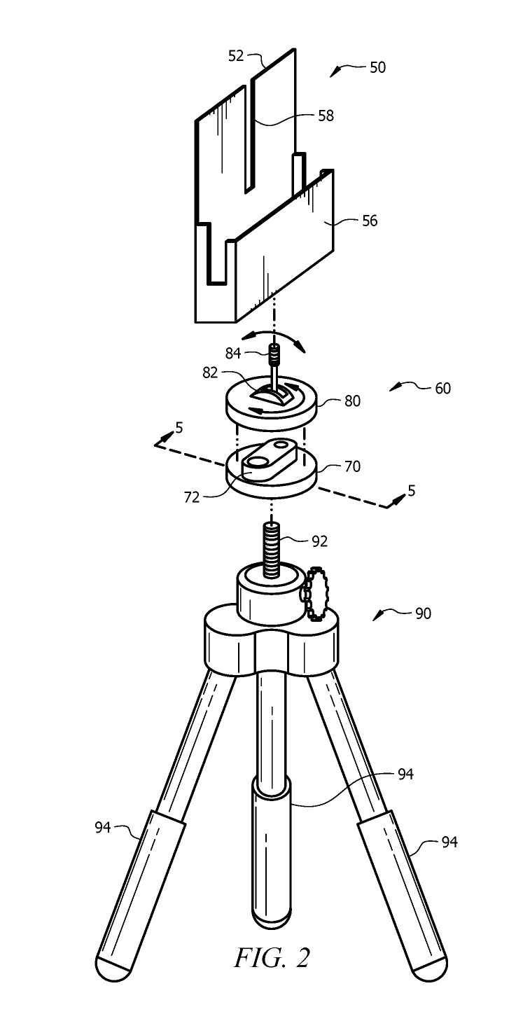

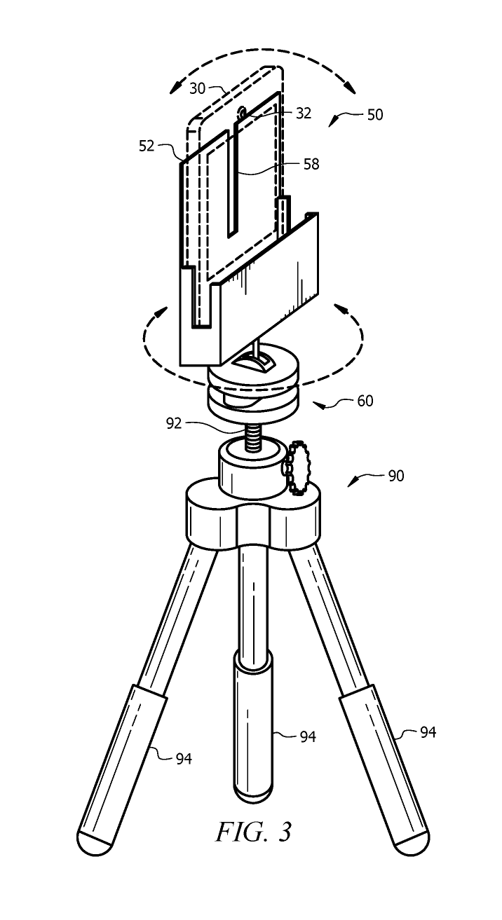

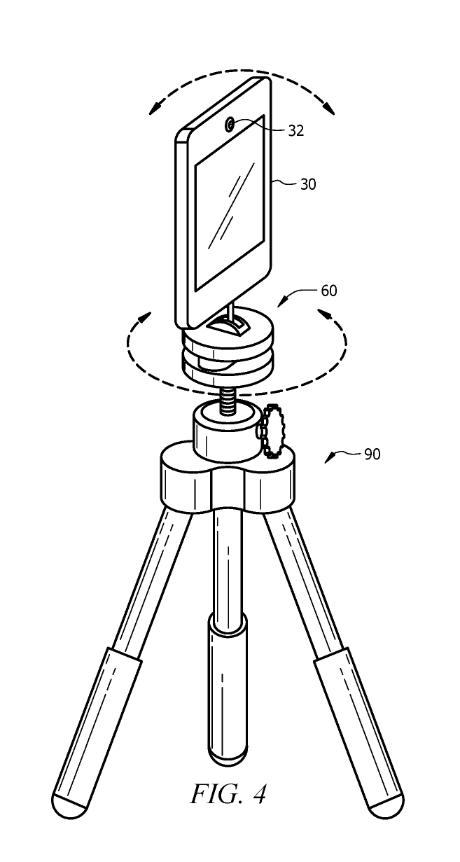

Referring to FIGS. 2-4, views of an angle adjustment device 60 used in conjunction with a tripod 90 and device holder 50 are shown. Although the device holder 50 is shown similar to the previously disclosed holder 10, it is anticipated that the angle adjustment device 60 be used with any type of holder 10/50 or attached directly to a device 30. As an example, the device holder 50 shown in FIGS. 2-4 has a front wall 56, a back wall 52 and, optionally, a slot 58 for cable routing, should a cable attachment to the device 30 be required (e.g. for power and/or control).

Likewise, although shown being used with a tripod 90, the angle adjustment device 60 is anticipated to be used with any base device or, in some embodiments, the angle adjustment device 60 includes sufficient mass as to support the device 30 without an additional base device. For completeness, the tripod 90 is shown having a tripod interface 92 (typically a threaded post) and legs 94 (any number of legs 94). Although the angle adjustment device 60 is shown interfaced to a tripod 90, it is anticipated that the angle adjustment device 60 interface to or be part of a selfie stick as it is often desired to change rotation and angle of a device 30 held by a selfie stick.

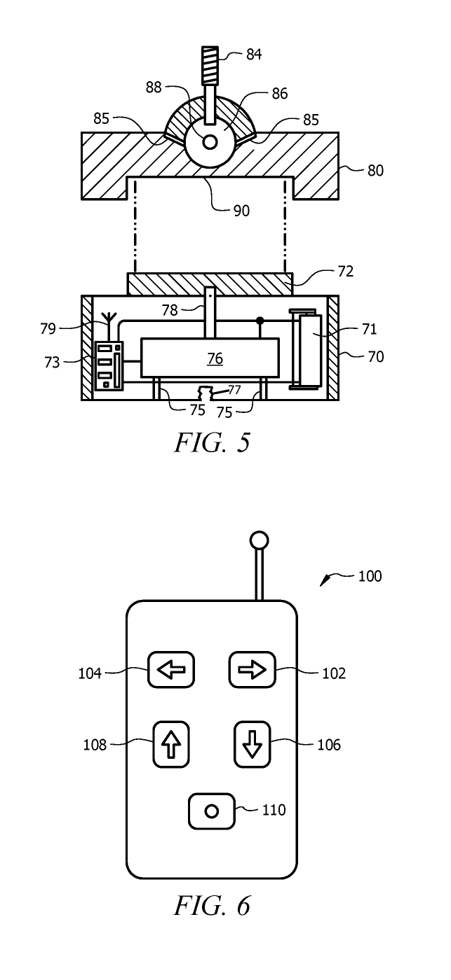

The angle adjustment device 60 includes two electrically operated actuation devices 76/86 (see FIG. 5) such as any combination of motors, servo-motor, electromagnetically operated ratchets, solenoid, etc. The electrically operated actuation devices 76/86 impart movement of the device 30 as shown by the arrows in FIGS. 2-4, including tilt (e.g. movement in relationship to the horizon) and rotation (e.g. movement in a plane of the horizon), though such tilt and rotation is not limited in direction, as it is anticipated that the angle adjustment device 60 be orientated in any direction.

In the examples shown in FIGS. 2-4, the angle adjustment device 60 includes a lower portion 70 that has a first electrically operated actuation device 76 that, upon receiving a control signal, rotates an upper portion 80 that has a second electrically operated actuation device 86, thereby adjusting a rotation angle of the device 60. Upon receiving a second control signal, the second electrically operated actuation device 86 tilts the device 30, for example, along a radius shaped opening 82, thereby adjusting a tilt angle of the device 30. The control signals are electrical signals received, for example, from a remote control 100 (see FIG. 6) either wirelessly or through wires. Note, in some embodiments, the control signals are received directly from the device 30, for example, as Bluetooth commands. In such, the device 30, for example being a smartphone, has the ability to adjust the rotation and tilt for adjusting before taking a picture. In such, software running on the device 30 (e.g. the smartphone) uses a camera 32 of the device to view the subject and, by sending commands to the angle adjustment device 60, the software has the ability to rotate and tilt the device 30 to fine-tune before taking a picture. It is anticipated that the device 30 be interfaced to the angle adjustment device 60 by an angle adjustment device interface 84 such as a threaded post as shown in FIG. 2.

In the examples shown in FIGS. 2-4, the angle adjustment device 60 interfaces to the tripod interface 92 (e.g. the angle adjustment device 60 has a receiver 77 that matches the tripod interface 92 such as a threaded hole as shown. It is fully anticipated that the angle adjustment device 60 has any such interface or is integrated to an object such as a tripod 90 or has sufficient mass as to self-support.

Referring to FIG. 5, a cross-sectional view of the angle adjustment device 60 along lines 5-5 of FIG. 2 is shown. In this example, the electrically operated actuation devices 76/86 are shown as motors, but as previously stated, any electrically operated actuation devices 76/86 are anticipated such as motors, servo-motor, electromagnetically operated ratchets, solenoid, etc.

The lower portion enclosure 70 of the angle adjustment device 60 includes the first electrically operated actuation device 76 that imparts rotation. In this, the first electrically operated actuation device 76 is held within the lower portion enclosure 70 and has a shaft 78 that rotates under electrical controls received from a controller 73. The shaft 78 is coupled to an interface member 72 that rotates in response to rotation of the shaft 78. The interface member 72 is coupled to the upper portion enclosure 80 so that, when the interface member 72 rotates, so does the upper portion enclosure 80 and, so does a device 30 interfaced to the angle adjustment device interface 84.

In the example shown, the controller 73 receives command signals wirelessly (e.g. using an internal antenna 79), though any known control system is anticipated, including a wired interface. Power is preferably provided from a power source 71 (e.g. battery) which, in embodiments where mass is needed to provide stability, the power source 71 contributes to such mass. Although one controller 73 and one power source 71 are shown located in the lower portion enclosure 70, there is no requirement as to the location and/or number of controllers 73 and power sources 71 (e.g. batteries). For example, it is fully anticipated that the controller 73 and the power source 71 be located in the upper portion enclosure 80 or one set of a controller 73 and a power source 71 located in the upper portion enclosure 80 and another set of a controller 73 and a power source 71 be located in the lower portion enclosure 70.

The upper portion enclosure 80 of the angle adjustment device 60 includes the second electrically operated actuation devices 86 that imparts tilt. In this, the second electrically operated actuation device 86 is held within the upper portion enclosure 80 and has a shaft 88 that rotates under electrical controls received from a controller 73. The shaft 88 is coupled to a disk 86 that rotates in response to rotation of the shaft 88. The disk 86 is coupled to the angle adjustment device interface 84 so that, when the interface disk 86 rotates, the angle adjustment device interface 84 follows and changes angle, thereby imparting a tilting motion to a device 30 that is interfaced to the angle adjustment device interface 84. Any wired or wireless interface between the upper portion enclosure 80 and second electrically operated actuation device 86 is anticipated.

In some embodiments, the angle adjustment device 60 is controlled in an auto-scan mode to continuously scan across a room, either under control of only the controller 73, or through receiving commands from a master, such as from the device 30. In this, as the device 30 detects movement within the room, it is anticipated that the device command the angle adjustment device 60 to tilt/rotate the device 30 to track the movement as detected by the device 30.

Referring to FIG. 6, a plan view of a remote control 100 for use with the angle adjustment device 60 is shown. As stated prior, the angle adjustment device 60 receives commands to impart motion of a device 30 that is interfaced to the angle adjustment device interface 84. Although there is no restriction as to the origin of such commands, for completeness, an exemplary remote control 100 is shown in FIG. 6. The exemplary remote control 100 is shown having a rotated left button 104, a rotate right button 102, a tilt forward button 108 and a tilt backward button 106. In addition, in some embodiments, a “take picture” button 110 is also provided. In this example, when one of the buttons 102/104/106/108 is operated, a wireless command signal is sent to the controller 73 and decoded, thereby operating one or both of the electrically operated actuation devices 76/86 to impart rotation and/or tilt of the device 30 that is interfaced to the angle adjustment device 60 by way of the angle adjustment device interface 84.

Likewise, when the “take picture” button 110 is operated, a wireless command signal is sent to the controller 73 and/or device 30 and decoded, thereby initiating taking of a picture (or video) by the device 30.

Although any wireless or wired interface is anticipated, an example of one wireless interface anticipated is Bluetooth, in which, the remote control 100 is paired with the controller 73 and/or the device 30 for controlling of motion of the angle adjustment device 60 and/or for initiation of taking a picture.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An angle adjustment device comprising:
a device interface;
a first electrically operated actuation device coupled to the device interface, the first electrically operated actuation device adjusting an angle of the device interface under electrical control from a controller; and
a second electrically operated actuation device coupled to the first electrically operated actuation device, the second electrically operated actuation device adjusting a rotation angle of the device interface under electrical control from the controller.

2. The angle adjustment device of claim 1, wherein the controller receives wireless controls from a remote control.

3. The angle adjustment device of claim 1, wherein the device interface is a threaded post.

4. The angle adjustment device of claim 1, wherein the device interface is a device holder.

5. The angle adjustment device of claim 1, wherein the first electrically operated actuation device is a first motor.

6. The angle adjustment device of claim 1, wherein the second electrically operated actuation device is a second motor.

7. The angle adjustment device of claim 1, wherein the second electrically operated actuation device is coupled to a receiver for receiving a tripod interface.

8. An angle adjustment device comprising:
a device interface;
a first electrically operated actuation device held within an upper portion enclosure, the first electrically operated actuation device is coupled to the device interface so as upon receipt of a first electrical signal from a controller, the first electrically operated actuation device adjusts an angle of the device interface; and
a second electrically operated actuation device held within a lower portion enclosure, the upper portion enclosure interfaced to the second electrically operated actuation device so as upon receipt of a second electrical signal from the controller, the second electrically operated actuation device adjusts a rotation angle of the upper portion enclosure and, therefore, a rotation angle of the device interface.

9. The angle adjustment device of claim 8, wherein the controller receives wireless controls from a remote control.

10. The angle adjustment device of claim 8, wherein the device interface is a threaded post.

11. The angle adjustment device of claim 8, wherein the device interface is a device holder.

12. The angle adjustment device of claim 8, wherein the first electrically operated actuation device is a first motor.

13. The angle adjustment device of claim 8, wherein the second electrically operated actuation device is a second motor.

14. The angle adjustment device of claim 8, wherein the second electrically operated actuation device is coupled to a receiver for receiving a tripod interface.

15. An angle adjustment device comprising:
a device interface;
a first motor held within an upper portion enclosure, the first motor is coupled to the device interface so as upon receipt of a first electrical signal from a controller, the first motor adjusts an angle of the device interface;
a second motor held within a lower portion enclosure, the upper portion enclosure interfaced to the second motor so as upon receipt of a second electrical signal from the controller, the second motor adjusts a rotation angle of the upper portion enclosure and, therefore, a rotation angle of the device interface; and
the lower portion enclosure having a receiver for receiving a tripod interface.

16. The angle adjustment device of claim 15, wherein the controller receives wireless controls from a remote control.

17. The angle adjustment device of claim 15, wherein the controller receives wireless Bluetooth commands.

18. The angle adjustment device of claim 15, wherein the device interface is a threaded post.

19. The angle adjustment device of claim 15, wherein the device interface is a device holder.

20. The angle adjustment device of claim 15, wherein the receiver for receiving the tripod interface is a threaded hole.
